(19) United States
(12) Patent Application Publication
(10) Pub. No.: US 2025/0225688 A1
(43) Pub. Date: Jul. 10, 2025

(54) IMAGE GENERATION USING DOMAIN TRANSFORMATION

(71) Applicant: SparkCognition, Inc., Austin, TX (US)

(72) Inventors: Kevin Gullikson, Pflugerville, TX (US); Mrinal Kanti Sen, Austin, TX (US); Arnab Dhara, Austin, TX (US); Ram Tuvi, Austin, TX (US)

(21) Appl. No.: 19/013,084

(22) Filed: Jan. 8, 2025

Related U.S. Application Data
(60) Provisional application No. 63/619,124, filed on Jan. 9, 2024.

(51) Int. Cl. G06T 11/00

(52) U.S. Cl. CPC G06T 11/00

(57) ABSTRACT

A system includes one or more processors configured to obtain first data representing waveform returns in terms of time, location, and ray parameter. The one or more processors are also configured to provide, as input to one or more machine-learning models, input data frames to generate output data in terms of time, location, and velocity. Each input data frame includes a sampled portion of the first data, an interpolated portion of the first data, or both. The one or more processors are further configured to generate, based on the output data, one or more images representing structures of an observed area associated with the waveform returns.

### CROSS-REFERENCE TO RELATED APPLICATION

The present application claims priority from U.S. Provisional Patent Application No. 63/619,124 filed Jan. 9, 2024, the entire content of which is incorporated by reference herein in its entirety.

### FIELD

The present disclosure is generally related to generating images based on waveform returns.

### BACKGROUND

Conceptually, a “forward problem” attempts to make a prediction based on a model of causal factors associated with a system and initial conditions of the system. An “inverse problem” reverses the forward problem by attempting to model causal factors and initial conditions based on data (e.g., measurements or other observations of the system). Stated another way, an inverse problem starts with the effects (e.g., measurement or other data) and attempts to determine model parameters, whereas the forward problem starts with the causes (e.g., a model of the system) and attempts to determine the effects. Inverse problems are used for many remote sensing applications, such as radar, sonar, medical imaging, computer vision, seismic imaging, etc.

Optimization techniques are commonly used to generate solutions to inverse problems. For example, with particular assumptions about a system that generated a set of return data, a reverse time migration technique can be used to generate image data representing the system. However, images generated using such techniques generally include artifacts. Such artifacts can be reduced by increasing the quantity of data used to generate the solution; however, generating more data is costly and time consuming. Furthermore, the computing resources required to perform optimization increase dramatically as the amount of data increases.

### SUMMARY

The present disclosure describes systems and methods to generate images based on waveform returns.

In some aspects, a system includes one or more processors configured to obtain first data representing waveform returns in terms of time, location, and a ray parameter.

The one or more processors are also configured to provide, as input to one or more machine-learning models, input data frames to generate output data in terms of time, location, and velocity. Each input data frame includes a sampled portion of the first data, an interpolated portion of the first data, or both. The one or more processors are further configured to generate, based on the output data, one or more images representing structures of an observed area associated with the waveform returns.

In some aspects, a method includes obtaining, by one or more processors, first data representing waveform returns in terms of time, location, and a ray parameter. The method also includes providing, by the one or more processors, input data frames as input to one or more machine-learning models to generate output data in terms of time, location, and velocity. Each input data frame includes a sampled portion of the first data, an interpolated portion of the first data, or both. The method further includes generating, by the one or more processors, one or more images based on the output data. The one or more images represent structures of an observed area associated with the waveform returns.

In some aspects, a computer-readable storage device stores instructions that are executable by one or more processors to cause the one or more processors to obtain first data representing waveform returns in terms of time, location, and a ray parameter. The instructions also cause the one or more processors to provide, as input to one or more machine-learning models, input data frames to generate output data in terms of time, location, and velocity. Each input data frame includes a sampled portion of the first data, an interpolated portion of the first data, or both. The instructions further cause the one or more processors to generate, based on the output data, one or more images representing structures of an observed area associated with the waveform returns.

In some aspects, a system includes one or more processors configured to obtain waveform return data representing waveform returns associated with one or more shots. The one or more processors are also configured to perform one or more domain transform operations based on the waveform return data to determine tau-p domain data representing the waveform returns. The one or more processors are further configured to generate, based on the tau-p domain data, tau-p domain data frames. Each tau-p domain data frame is associated with a corresponding p value. The one or more processors are also configured to provide each tau-p domain data frame as input to a corresponding channel of a multi-channel convolutional neural network to generate as output one or more time-domain velocity models. The one or more processors are further configured to generate, based on the one or more time-domain velocity models, one or more images representing structures of an observed area associated with the waveform returns.

In some aspects, a method includes obtaining, by one or more processors, waveform return data representing waveform returns associated with one or more shots. The method also includes performing, by the one or more processors, one or more domain transform operations based on the waveform return data to determine tau-p domain data representing the waveform returns. The method further includes generating, by the one or more processors, tau-p domain data frames based on the tau-p domain data. Each tau-p domain data frame is associated with a corresponding p value. The method also includes providing, by the one or more processors, each tau-p domain data frame as input to a corresponding channel of a multi-channel convolutional neural network to generate as output one or more time-domain velocity models. The method further includes generating, by the one or more processors, one or more images based on the one or more time-domain velocity models, the one or more images representing structures of an observed area associated with the waveform returns.

In some aspects, a computer-readable storage device stores instructions that are executable by one or more processors to cause the one or more processors to obtain waveform return data representing waveform returns associated with one or more shots. The instructions also cause the one or more processors to perform one or more domain transform operations based on the waveform return data to determine tau-p domain data representing the waveform returns. The instructions further cause the one or more processors to generate, based on the tau-p domain data, tau-p domain data frames. Each tau-p domain data frame is associated with a corresponding p value. The instructions also cause the one or more processors to provide each tau-p domain data frame as input to a corresponding channel of a multi-channel convolutional neural network to generate as output one or more time-domain velocity models. The instructions further cause the one or more processors to generate, based on the one or more time-domain velocity models, one or more images representing structures of an observed area associated with the waveform returns.

### BRIEF DESCRIPTION OF THE DRAWINGS

FIG. 1 is a diagram illustrating particular aspects of a system to generate one or more images based on waveform return data.

FIG. 2 is a diagram that illustrates an example of an architecture for a machine-learning model of the system of FIG. 1.

FIG. 3 is a diagram of illustrative aspects of operation of the system of FIG. 1.

FIG. 4 is a flow chart of an example of a method of generating one or more images based on waveform return data.

FIG. 5 is a flow chart of an example of a method of generating one or more images based on waveform return data.

FIG. 6 illustrates an example of a computer system configured to use machine-learning to generate one or more images based on waveform return data in accordance with some aspects of the present disclosure.

### DETAILED DESCRIPTION

The present disclosure describes systems and methods to generate image data (e.g., an image of an observed area) using waveform return data representing waveform returns. The waveform return data can include data based on records (referred to herein as “waveform return records”) for multiple sampling events associated with the observed area. The image data represents a solution to an inverse problem associated with the waveform return data. For example, the waveform return data may be generated by a seismic imaging system that includes one or more sources and one or more receivers. In this example, during a particular sampling event (also referred to herein as a “shot”), the source(s) cause one or more waveforms to propagate in the observed area. Subsurface features within the observed area reflect the waveform(s), and the receiver(s) generate measurements (“waveform return measurements”) that indicate, for example, a magnitude of a received waveform return, a timing of receipt of the waveform return, etc. In this example, a waveform return record of the particular sampling event may include the waveform return measurements generated by the receiver(s) for the particular sampling event. Further, in this example, the waveform return data for the particular sampling event may be identical to the waveform return record, or the waveform return data may represent the waveform return record after particular data transformation operations are performed. To illustrate, the waveform return records generally include time-series data, and the waveform return data may include time-series data or may include depth domain data or images based on the time-series data.

Techniques disclosed herein facilitate generation of image(s) based on waveform return data in an efficient manner. Further, the techniques described herein are flexible, enabling efficient generation of images based on waveform return data generated by sensing systems with a variety of configurations. For example, the techniques described herein can be used for different numbers and arrangements of sources and receivers in a sampling system. The disclosed techniques are also readily scalable. For example, in disclosed embodiments, tau-p domain data is generated based on any number of shots (e.g., one shot or many shots). Data frames of the tau-p domain data can be generated via framing and/or interpolation operations and used to generate time-domain velocity model(s). Thus, the size of the input data is related to the number of data frames used, and is independent of the number of receivers, the number of shots or shot records, etc. For example, for seismic imaging, it would not be uncommon for shot data to include shot traces from thousands or tens of thousands of receivers, and the techniques disclosed herein can use in the neighborhood of ten frames of tau-p domain data as a compressed representation of that shot data. Thus, the shot data analyzed can be reduced by several orders of magnitude, which enables a significant reduction in computing resources used.

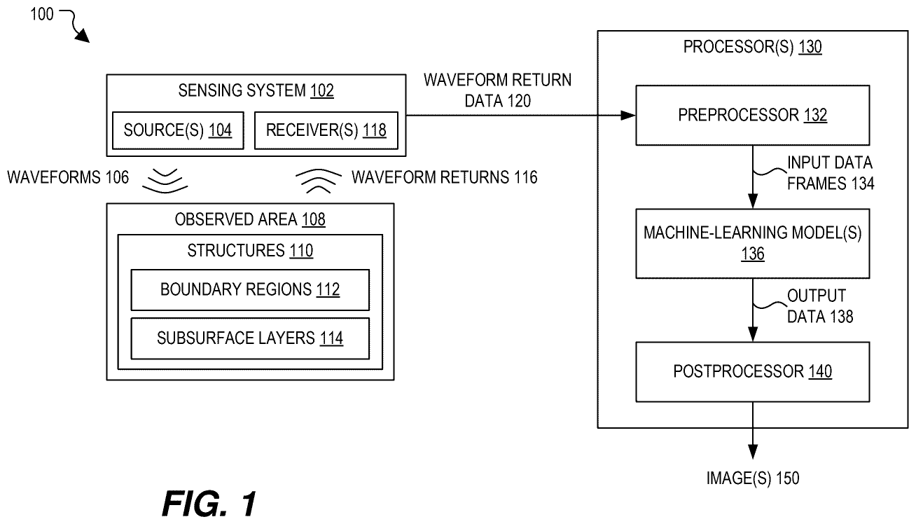

Particular aspects of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a system 100 including one or more processors (“processor(s)” 130 of FIG. 1), which indicates that in some implementations the system 100 includes a single processor 130 and in other implementations the system 100 includes multiple processors 130. For ease of reference herein, such features are generally introduced as “one or more” features and are subsequently referred to in the singular or optional plural (as indicated by “(s)”) unless aspects related to multiple of the features are being described.

As used herein, an ordinal term (e.g., “first,” “second,” “third,” “Nth,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements. Additionally, in some instances, an ordinal term herein may use a letter (e.g., “Nth”) to indicate an arbitrary or open-ended number of distinct elements (e.g., zero or more elements). Different letters (e.g., “N” and “M”) are used for ordinal terms that describe two or more different elements when no particular relationship among the number of each of the two or more different elements is specified. For example, unless defined otherwise in the text, N may be equal to M, N may be greater than M, or N may be less than M.

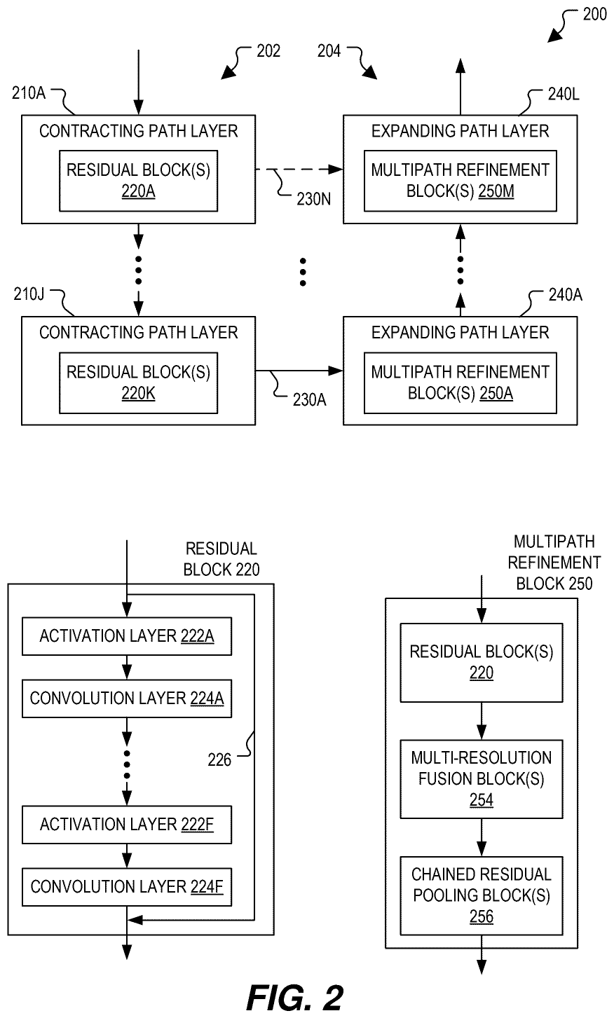

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter. For example, referring to FIG. 2, multiple convolution layers 224 are illustrated and associated with reference numbers 224A to 224F. When referring to a particular one of these locations, such as a convolution layer 224A, the distinguishing letter “A” is used. However, when referring to any arbitrary one of these convolution layers or to these convolution layers as a group, the reference number 224 is used without a distinguishing letter.

Further the terms “comprise,” “comprises,” and “comprising” may be used interchangeably with “include,” “includes,” or “including.” Additionally, the term “wherein” may be used interchangeably with “where.” As used herein, “exemplary” may indicate an example, an implementation, and/or an aspect, and should not be construed as limiting or as indicating a preference or a preferred implementation.

In the present disclosure, terms such as “determining,” “obtaining,” “calculating,” “estimating,” “shifting,” “adjusting,” etc. may be used to describe how one or more operations are performed. Such terms are not to be construed as limiting and other techniques may be utilized to perform similar operations. Additionally, as referred to herein, “generating,” “obtaining,” “calculating,” “estimating,” “using,” “selecting,” “accessing,” and “determining” may be used interchangeably. For example, “generating,” “obtaining,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model”). Typically, a machine-learning model is generated using a first data set to facilitate analysis of a second data set. For example, a first portion of a large body of data may be used to generate a machine-learning model that can be used to analyze the remaining portion of the large body of data. As another example, a set of historical data can be used to generate a machine-learning model that can be used to analyze future data.

Since a machine-learning model can be used to evaluate a set of data that is distinct from the data used to generate the machine-learning model, machine-learning models can be viewed as a type of software (e.g., instructions, parameters, or both) that is automatically generated by the computer(s) during the machine learning process. As such, machine-learning models can be portable (e.g., can be generated at a first computer, and subsequently moved to a second computer for further training, for use, or both). Additionally, a machine-learning model can be used in combination with one or more other machine-learning models to perform a desired analysis. To illustrate, first data can be provided as input to a first machine-learning model to generate first model output data, which can be provided (alone, with the first data, or with other data) as input to a second machine-learning model to generate second model output data indicating a result of a desired analysis. Depending on the analysis and data involved, different combinations of machine-learning models may be used to generate such results. In some examples, multiple machine-learning models may provide model output that is input to a single machine-learning model. In some examples, a single machine-learning model provides model output to multiple machine-learning models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows-a creation/training phase and a runtime phase. During the creation/training phase, a machine-learning model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the machine-learning model is used to analyze input data to generate model output. The content of the model output depends on the type of model. For example, a machine-learning model can be trained to perform classification tasks or regression tasks, as non-limiting examples. In some implementations, a machine-learning model may be continuously, periodically, or occasionally updated, in which case training time and runtime may be interleaved or one version of the machine-learning model can be used for inference while a copy is updated, after which the updated copy may be deployed for inference.

In some implementations, a previously generated model is trained (or re-trained) using a machine-learning technique. In this context, “training” refers to adapting the machine-learning model or parameters of the machine-learning model to a particular data set. Unless otherwise clear from the specific context, the term “training” as used herein includes “re-training” or refining a machine-learning model for a specific data set. For example, training may include so called “transfer learning.” As described further below, in transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Machine-learning models can be initialized from scratch (e.g., by a user, such as a data scientist) or using a guided process (e.g., using a template or previously built model). Initializing the machine-learning model includes specifying parameters and hyperparameters of the machine-learning model. “Hyperparameters” are characteristics of a machine-learning model that are not modified during training, and “parameters” of the machine-learning model are characteristics of the machine-learning model that are modified during training. The term “hyperparameters” may also be used to refer to parameters of the training process itself, such as a learning rate of the training process. In some examples, the hyperparameters of the machine-learning model are specified based on the task the machine-learning model is being created for, such as the type of data the machine-learning model is to use, the goal of the machine-learning model (e.g., classification, regression, anomaly detection), etc. The hyperparameters may also be specified based on other design goals associated with the machine-learning model, such as a memory footprint limit, where and when the machine-learning model is to be used, etc.

Model type and model architecture of a machine-learning model illustrate a distinction between model generation and model training. The model type of a machine-learning model, the model architecture of the machine-learning model, or both, can be specified by a user or can be automatically determined by a computing device. However, neither the model type nor the model architecture of a particular machine-learning model is changed during training of the particular machine-learning model. Thus, the model type and model architecture are hyperparameters of the machine-learning model and specifying the model type and model architecture is an aspect of model generation (rather than an aspect of model training). In this context, a “model type” refers to the specific type or sub-type of the machine-learning model. As noted above, examples of machine-learning model types include, without limitation, perceptrons, neural networks, support vector machines, regression models, decision trees, Bayesian models, Boltzmann machines, adaptive neuro-fuzzy inference systems, as well as combinations, ensembles and variants of these and other types of models. In this context, “model architecture” (or simply “architecture”) refers to the number and arrangement of model components, such as nodes or layers, of a machine-learning model, and which model components provide data to or receive data from other model components. As a non-limiting example, the architecture of a neural network may be specified in terms of nodes and links. To illustrate, a neural network architecture may specify the number of nodes in an input layer of the neural network, the number of hidden layers of the neural network, the number of nodes in each hidden layer, the number of nodes of an output layer, and which nodes are connected to other nodes (e.g., to provide input or receive output). As another non-limiting example, the architecture of a neural network may be specified in terms of layers. To illustrate, the neural network architecture may specify the number and arrangement of specific types of functional layers, such as long-short-term memory (LSTM) layers, fully connected (FC) layers, convolution layers, etc. While the architecture of a neural network implicitly or explicitly describes links between nodes or layers, the architecture does not specify link weights. Rather, link weights are parameters of a machine-learning model (rather than hyperparameters of the machine-learning model) and are modified during training of the machine-learning model.

Another example of training a previously generated machine-learning model is transfer learning. “Transfer learning” refers to initializing a machine-learning model for a particular data set using a machine-learning model that was trained using a different data set. For example, a “general purpose” machine-learning model can be trained to detect anomalies in vibration data associated with a variety of types of rotary equipment, and the general-purpose machine-learning model can be used as the starting point to train a machine-learning model for one or more specific types of rotary equipment, such as a first machine-learning model for generators and a second machine-learning model for pumps. As another example, a general-purpose natural-language processing model can be trained using a large selection of natural-language text in one or more target languages. In this example, the general-purpose natural-language processing model can be used as a starting point to train one or more models for specific natural-language processing tasks, such as translation between two languages, question answering, or classifying the subject matter of documents. As another example, a general-purpose image processing model can be trained using a large selection of waveform return data. In this example, the general-purpose image processing model can be used as a starting point to train one or more models for a specific observed area (e.g., a specific geographic region). In some situations, some or all of the data used to train a general-purpose machine-learning model can include simulated data (e.g., simulated waveform returns), and some or all of the training data used during transfer learning to refine the general-purpose machine-learning model can include real-world data (e.g., waveform returns gathered during real-world sampling events). Often, transfer learning can converge to a useful machine-learning model more quickly than building and training the machine-learning model from scratch. In general, a machine-learning model can be configured to perform some task or set of tasks, where “configuring” a machine-learning model in this context includes determining or setting an architecture of the machine-learning model, determining or setting hyperparameters of the machine-learning model, and training (optionally including retraining) the machine-learning model, and possibly other operations, to enable the machine-learning model to perform the task(s).

Training a machine-learning model based on a training data set generally involves changing parameters of the machine-learning model with a goal of causing the output of the machine-learning model to have particular characteristics based on data input to the machine-learning model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a machine-learning model, during supervised training of a neural network, an input data sample is associated with a label. When the input data sample is provided to the machine-learning model, the machine-learning model generates output data, which is compared to the label associated with the input data sample to generate an error value. Parameters of the machine-learning model are modified in an attempt to reduce (e.g., optimize) the error value.

As another example, to use supervised training to train a machine-learning model to perform a classification task, each data element of a training data set may be labeled to indicate a category or categories to which the data element belongs. In this example, during the creation/training phase, data elements are input to the machine-learning model being trained, and the machine-learning model generates output indicating categories to which the machine-learning model assigns the data elements. The category labels associated with the data elements are compared to the categories assigned by the machine-learning model. The computer modifies the machine-learning model until the machine-learning model accurately and reliably (e.g., within some specified criteria) assigns the correct labels to the data elements. In this example, the machine-learning model can subsequently be used (in a runtime phase) to receive unknown (e.g., unlabeled) data elements, and assign labels to the unknown data elements. In an unsupervised training scenario, the labels may be omitted. During the creation/training phase, model parameters may be tuned by the training algorithm in use such that during the runtime phase, the machine-learning model is configured to determine which of multiple unlabeled “clusters” an input data sample is most likely to belong to.

As another example, to train a machine-learning model to perform a regression task, during the creation/training phase, one or more data elements of the training data are input to the machine-learning model being trained, and the machine-learning model generates output indicating a predicted value of one or more other data elements of the training data. The predicted values of the training data are compared to corresponding actual values of the training data, and the computer modifies the machine-learning model until the machine-learning model accurately and reliably (e.g., within some specified criteria) predicts values of the training data. In this example, the machine-learning model can subsequently be used (in a runtime phase) to receive data elements and predict values that have not been received. To illustrate, the machine-learning model can analyze time-series data, in which case, the machine-learning model can predict one or more future values of the time series based on one or more prior values of the time series.

In some aspects, the output of a machine-learning model can be subjected to further analysis operations to generate a desired result. To illustrate, in response to particular input data, a classification model (e.g., a machine-learning model trained to perform classification tasks) may generate output including an array of classification scores, such as one score per classification category that the machine-learning model is trained to assign. Each score is indicative of a likelihood (based on the machine-learning model's analysis) that the particular input data should be assigned to the respective category. In this illustrative example, the output of the machine-learning model may be subjected to a softmax operation to convert the output to a probability distribution indicating, for each category label, a probability that the input data should be assigned the corresponding label. In some implementations, the probability distribution may be further processed to generate a one-hot encoded array. In other examples, other operations that retain one or more category labels and a likelihood value associated with each of the one or more category labels can be used.

FIG. 1 is a diagram illustrating particular aspects of a system 100 to generate image(s) 150 based on waveform returns 116 in accordance with some aspects of the present disclosure. In FIG. 1, the system 100 includes a sensing system 102 and one or more processors 130. The sensing system 102 is configured to generate waveform return data 120 for an observed area 108, and the processor(s) 130 are configured to use the waveform return data 120 to generate the image(s) 150.

The sensing system 102 includes one or more sources 104 and one or more receivers 118. The source(s) 104 are configured to emit waveforms 106 into the observed area 108. Structures 110 in the observed area 108, such as boundary regions 112 around subsurface layers 114 of the observed area 108 cause the waveform 106 to be reflected back toward a surface of the observed area 108. The receivers 118 are configured to detect the waveform returns 116 resulting from the reflection of the waveforms 106 and to generate the waveform return data 120 based on the waveform returns 116. Portions of the waveforms 106 may be refracted by a first of the subsurface layers 114 (e.g., a layer at a first depth) and reflected from a second of the subsurface layers 114 (e.g., a layer at a second depth that is below the first depth).

In some implementations, the waveform return data 120 include or correspond to time-series data, such as data indicating a delay between emission of a waveform 106 by a particular source 104 and receipt of a waveform return 116 by a particular receiver 118. In some implementations, time-series data of the waveform return data 120 also indicates an amplitude of the waveform 106, an amplitude of the waveform return 116, or both. When the sensing system 102 includes multiple receivers 118, the time-series data of the waveform return data 120 may include a time series associated with each receiver 118 or a stacked time series representing multiple receivers 118. Additionally, the waveform return data 120 may include or be accompanied by acquisition geometry data that indicates the positions of source(s) 104 and receiver(s) 118 when each waveform return 116 was received.

Emission of one or more waveforms 106 by the source(s) 104 and receipt of corresponding waveform returns 116 by the receiver(s) 118 represents a single sampling event. The waveform return data 120 may include at least one waveform return record (e.g., time-series data representing the waveform returns 116) for each sampling event. In some implementations, the waveform return data 120 include waveform return records for multiple sampling events. For example, in some implementations, the sensing system 102 may initiate multiple sensing events at a particular acquisition geometry in accordance with a test sequence. In the same or different implementations, the sensing system 102 may initiate sensing events at multiple different acquisition geometries in accordance with the test sequence. The time between emission of a particular waveform 106 and reception of a corresponding waveform return 116 at a particular receiver 118 is generally related to the depth of the subsurface layer 114 that reflected the waveform 106 and propagation velocity of the waveforms 106 in the various subsurface layers 114.

In the example illustrated in FIG. 1, the waveform return data 120 are provided to the processor(s) 130. FIG. 1 illustrates the sensing system 102 sending the waveform return data 120 to the processor(s) 130; however, in many implementations, the sensing system 102 generates the waveform return data 120 and stores data representing the waveform return data 120 at one or more data storage devices, and one or more computing devices including the processor(s) 130 obtain the waveform return data 120 (perhaps indirectly) from the data storage device(s).

As one particular example, the sensing system 102 may include a seismic data acquisition system. In this particular example, the source(s) 104 correspond to seismic pulse generation device(s) (such as an explosive device, an air gun, or a vibrator truck), and the receiver(s) 118 correspond to specialized microphone(s) (such as a geophone or a hydrophone). In this particular example, each sampling event may be referred to as a “shot,” and the waveform return records of the waveform return data 120 associated with that shot may be referred to as a “shot record.” In other examples, the sensing system 102 includes another type of data acquisition system, such as a sonar system, a radar system, a lidar system, an ultrasound imaging system, etc.

In the example illustrated in FIG. 1, the processor(s) 130 include a preprocessor 132, one or more machine-learning models 136, and a postprocessor 140. The preprocessor 132 is configured to perform preprocessing operations to prepare input data frames 134 based on the waveform return data 120 for input to the machine-learning model(s) 136. For example, the preprocessor 132 may normalize, filter, and/or augment the waveform return data 120. As another example, the preprocessor 132 performs one or more domain transform operations to convert the waveform return data 120 to another data domain. As one example, the waveform return data 120 can be received as time-domain data (e.g., in terms of time, location, and amplitude), and the preprocessor 132 can perform domain transform operation(s) (e.g., a linear Radon transformation) to represent the waveform return data 120 in a tau-p domain (e.g. in terms of tau, location, and ray parameter (p)).

In some implementations, the preprocessor 132 performs framing operations, interpolation operations, or both, to generate the input data frames 134 based on the tau-p-domain data. In such implementations, each input data frame 134 represents a corresponding ray parameter value. For example, the input data frames 134 can include a P=0 data frame, a P=0.3 data frame, etc. In a particular embodiment, the input data frames 134 are generated for ten, evenly spaced p values; however, the specific number and distribution of the p values used to generate the input data frames 134 can be different for different embodiments. In some embodiments, the number of p values corresponds to a number of input channels of the machine-learning model(s) 136.

The machine-learning model(s) 136 are configured to receive the input data frames 134 and generate the output data 138. For example, the machine-learning model(s) 136 can include a multi-channel input with each channel associated with a corresponding p value of the input data frames 134, and the output data 138 can include time-domain velocity model(s) representing the waveform return data 120 in terms of time, location, and velocity. In some embodiments, the time-domain velocity model(s) are an intermediate output of the machine-learning model(s) 136. For example, in such embodiments, the machine-learning model(s) 136 include one or more models or layers that are configured to generate the image(s) 150 based on the time-domain velocity model(s). To illustrate, one or more layers of the machine-learning model(s) 136 may be configured to perform integration operations to generate depth-domain image data (e.g., the image(s) 150) based on the time-domain velocity model(s). In some implementations, the postprocessor 140 may be configured to perform interpolation operations to generate depth-domain image data for a particular set of coordinates (e.g. a regular grid).

The postprocessor 140 is configured to perform preprocessing operations to generate or refine the image(s) 150. The postprocessor 140 is optional and is omitted in some embodiments. For example, when the machine-learning model(s) 136 are configured to generate the image(s) 150, as described above, the postprocessor 140 can be omitted or can be included and configured to modify the image(s) 150 generated by the machine-learning model(s) 136 (e.g., intermediate images). In embodiments that include the postprocessor 140, the postprocessor 140 can perform operations such as normalization, filtering, and/or image augmentation, based on the output data 138 or based on intermediate images generated by the machine-learning model(s) 136.

In some embodiments, the postprocessor 140 is configured to perform one or more domain transform operations to convert the output data 138 to another data domain. As one example, the output data 138 can be received as time-domain velocity model(s) (e.g., in terms of time, location, and velocity), and the postprocessor 140 can perform domain transform operation(s) (e.g., integration) to generate depth-domain data based on the output data 138.

The system 100 is able to generate the image(s) 150 efficiently (e.g. in terms of time, computing resources, memory utilization, etc.). For example, in some embodiments, the input data frames 134 include ten data frames representing corresponding p values, which can be determined (e.g., selected and/or interpolated) from among the tau-p data representing the waveform return data 120. By careful selection of the distribution of the p values used for framing, the input data frames 134 can represent the entire set of waveform return data 120 sufficiently to enable efficient generation of the image(s) 150. The use of input data frames 134 in the tau-p domain to generate output data 138 in the time-domain (e.g., as time-domain velocity model(s)) means the machine-learning model(s) 136 do not need to learn complex domain transformations, which allows the machine-learning model(s) 136 to generate more accurate output data 138. Further, since the waveform return data 120 represented in the tau-p domain can be readily framed or interpolated to the particular p values used for the input data frames 134, a variety of sampling events can be accommodated by the system 100. For example, the spacing between the source(s) 104 and the receiver(s) 118 can vary from one sampling event to another without interfering with operation of the system 100. As another example, the number of sources 104, the number of receivers 118, or both, can vary from sampling event to another without interfering with operation of the system 100.

FIG. 2 illustrates an example architecture for a machine-learning model 200, which can correspond to, include, or be included among the machine-learning model(s) 136 of FIG. 1. For example, the machine-learning model 200 may be configured to receive the input data frames 134 and generate the output data 138, as described with reference to FIG. 1. In the example illustrated in FIG. 2, the machine-learning model 200 uses an architecture based on the RefineNet architecture described in by Guosheng Lin, et al. in “RefineNet: Multi-Path Refinement Networks for High-Resolution Semantic Segmentation,” published 25 Nov. 2016, which is incorporated herein by reference. In other examples, the machine-learning model 200 can use another UNet-type architecture that includes a contracting path 202 interconnected with an expanding path 204.

In the example illustrated in FIG. 2, the contracting path 202 includes multiple contracting path layers 210. One or more of the contracting path layers 210 includes a residual block 220 (or multiple residual blocks 220). For example, a contracting path layer 210A includes residual block(s) 220A, and the contracting path layer 210J includes residual block(s) 220K (where J is an integer greater than 1 and K is an integer greater than or equal to 1). Each residual block 220 includes multiple activation layers 222, multiple convolution layers 224, and one or more skip connections 226. For example, the residual block 220 includes an activation layer 222A, and activation layer 222F, a convolution layer 224A, a convolution layer 224F (where F is an integer greater than 1).

In the example illustrated in FIG. 2, the expanding path 204 includes multiple expanding path layers 240. In particular, the expanding path 204 includes an expanding path layer 240A and an expanding path layer 240L (where L is an integer greater than 1). In some implementations, the expanding path 204 includes a single layer (e.g., the expanding path layer 240A).

The expanding path 204 includes at least one multipath refinement block 250. For example, in FIG. 2, one or more of the expanding path layers 240 includes a multipath refinement block 250. To illustrate, the expanding path layer 240A includes a multipath refinement block 250A, and the expanding path layer 240L includes a multipath refinement block 250M (where M is an integer greater than 1). Each of the multipath refinement block(s) 250 includes one or more residual blocks 220, one or more multi-resolution fusion blocks 254, and one or more chained residual pooling blocks 256.

The multi-resolution fusion block 254 is configured to convert two or more inputs of different dimensionality into a common dimensionality and to combine the converted inputs to generate combined data. For example, in some embodiments, the multi-resolution fusion block 254 includes one or more convolution layers configured to receive one or more inputs from the residual block(s) 220 (e.g., processed output from one or more contracting path layers 210 and/or from one or more expanding path layers 240) and to generate feature maps of the same dimensionality (e.g., dimensionality equal to a smallest among the inputs). In such embodiments, the multi-resolution fusion block 254 may also include one or more upsampling layers configured to up-sample the feature maps to the largest dimensionality among the inputs. The upsampled feature maps may be fused by summation. The chained residual pooling blocks 256 includes a chain of pooling blocks, each including a max-pooling layer and a convolution layer.

The machine-learning model 200 includes one or more interconnect paths 230 between the contracting path 202 and the expanding path 204. For example, in FIG. 2, an interconnect path 230A couples an output of the last layer of the contracting path 202 (e.g., contracting path layer 210J) to a first layer of the expanding path 204 (e.g., the expanding path layer 240A). In some examples, other layers of the contracting path 202 are interconnected to layers of the expanding path 204. To illustrate, in FIG. 2, the machine-learning model 200 includes an interconnect path 230N (where N is an integer greater than 1) connecting an output of the contracting path layer 210A to an input of the expanding path layer 240L.

In some embodiments, each contracting path layer 210 is connected, via a corresponding interconnect path 230, to a corresponding expanding path layer 240. For example, an input to each expanding path layer 240 may include an output of a contracting path layer 210. Each expanding path layer 240 subsequent to the first expanding path layer (e.g., the expanding path layer 240A) also includes an output of a proceeding expanding path layer 240. Contracting path layers 210 that receive input that includes the output of a contracting path layer 210 and output of a preceding expanding path layer 240 can concatenate the output of the contracting path layer 210 and the output of the preceding expanding path layer 240 for processing. In expanding path layers 240 that include one or more multipath refinement blocks 250, the multipath refinement block(s) 250 combine the outputs.

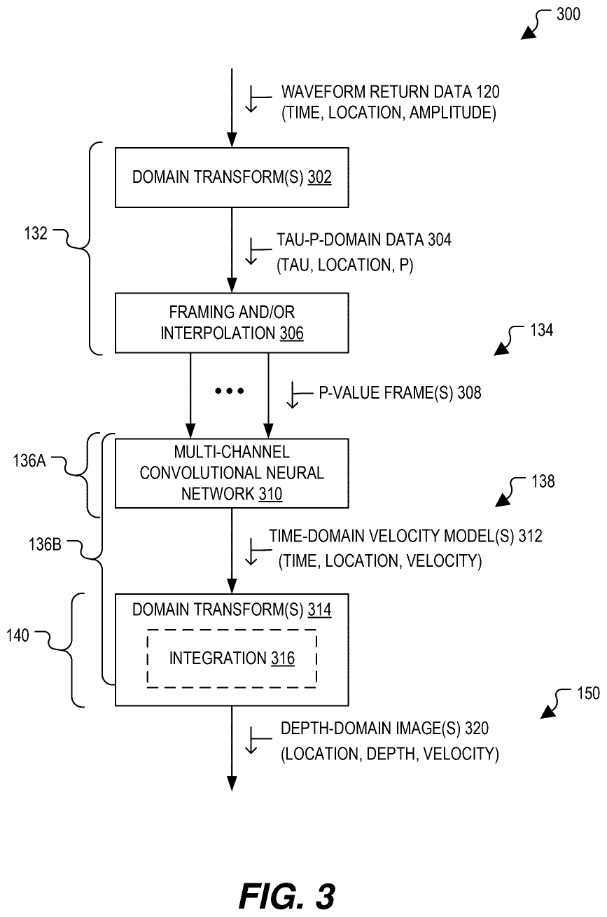

FIG. 3 is a diagram 300 of illustrative aspects of operation of the system of FIG. 1. For example, the operations described with reference to FIG. 3 may be performed by the processor(s) 130 executing instructions.

In FIG. 3, one or more domain transform operations 302 are performed on the waveform return data 120 of FIG. 1 to generate tau-p-domain data 304. For example, the waveform return data 120 can be represented in terms of time, location, and amplitude, and the tau-p-domain data 304 can be represented in terms of tau, location, and ray parameter (p).

Framing and/or interpolation operations 306 are performed based on the tau-p-domain data 304 to generate input data frames 134 for one or more machine-learning models. For example, the framing and/or interpolation operations 306 can generate one or more p-value frames 308, where each of the p-value frame(s) 308 represents a corresponding constant p value (e.g., a particular ray parameter value) and has dimensions of time and location. In the example illustrated in FIG. 3, the domain transform operation(s) 302 and the framing and/or interpolation operations 306 can be performed by the preprocessor 132.

The input data frames 134 are provided as input to one or more machine-learning models 136. In the example illustrated in FIG. 3, the machine-learning model(s) 136 include a multi-channel convolutional neural network 310. For example, each input channel of the multi-channel convolutional neural network 310 can be configured to receive an input data frame 134 associated with a particular ray parameter value. Stated another way, the multi-channel convolutional neural network 310 is configured to receive a set of frames representing waveform returns in terms of tau, location, and ray parameter (p), where each frame corresponds to a particular ray parameter value. The particular ray parameter values used correspond to the ray parameter values used during training of the multi-channel convolutional neural network 310 and can be different for different embodiments.

The multi-channel convolutional neural network 310 is configured to generate output data 138 that includes one or more time-domain velocity models 312 based on the waveform return data 120. In a particular aspect, the time-domain velocity model(s) 312 represent the output data 138 in terms of time, location, and velocity.

In FIG. 3, one or more domain transform operations 314 are performed on the time-domain velocity model(s) 312 to generate the image(s) 150. For example, the image(s) 150 in FIG. 3 include depth-domain image(s) 320 represented in terms of location, depth, and velocity. Characteristics of the depth-domain image(s) 320 are representative of the structures 110 of the observed area 108 of FIG. 1.

In some embodiments, the domain transform operation(s) 314 are performed by the postprocessor 140. In some embodiments, the domain transform operation(s) 314 (or a portion thereof) are performed by one or more trained or non-trainable layers (e.g., layers of the machine-learning model(s) 136). For example, the domain transform operation(s) 314 can include integration operations, based on the time-domain velocity model(s) 312.

In some embodiments, during training, a loss function used to evaluate performance of the multi-channel convolutional neural network 310 is based on the time-domain velocity model(s) 312. For example, training data provided to the multi-channel convolutional neural network 310 can be associated with a ground-truth time-domain velocity model. In this example, weights of the multi-channel convolutional neural network 310 can be updated to reduce differences between the time-domain velocity model(s) 312 and ground-truth the time-domain velocity model(s) 312. In some embodiments, the loss function used to evaluate performance of the multi-channel convolutional neural network 310 is based on the depth-domain image(s) 320. For example, training data provided to the multi-channel convolutional neural network 310 can be associated with a ground-truth depth-domain image. In this example, weights of the multi-channel convolutional neural network 310 can be updated to reduce differences between the depth-domain image(s) 320 and the ground-truth the depth-domain image.

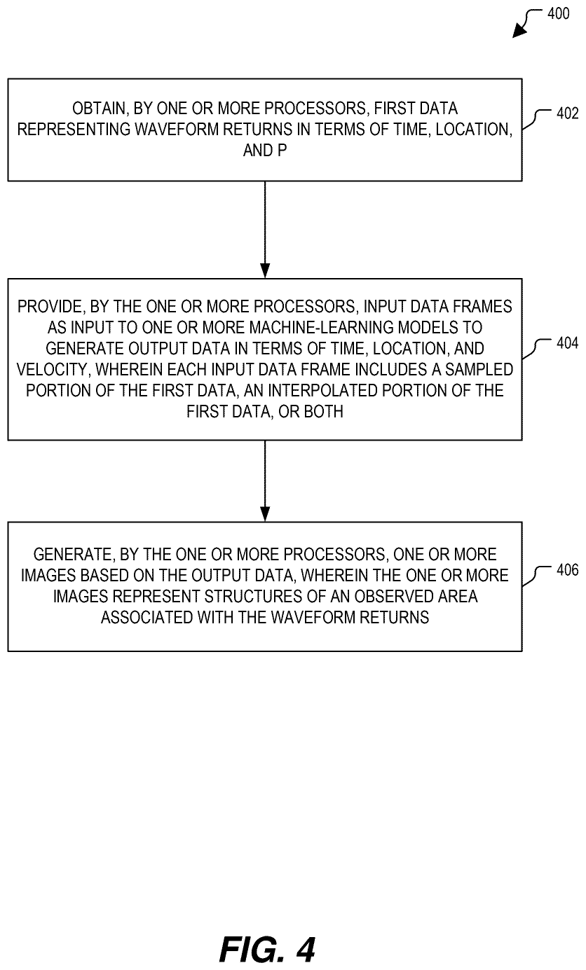

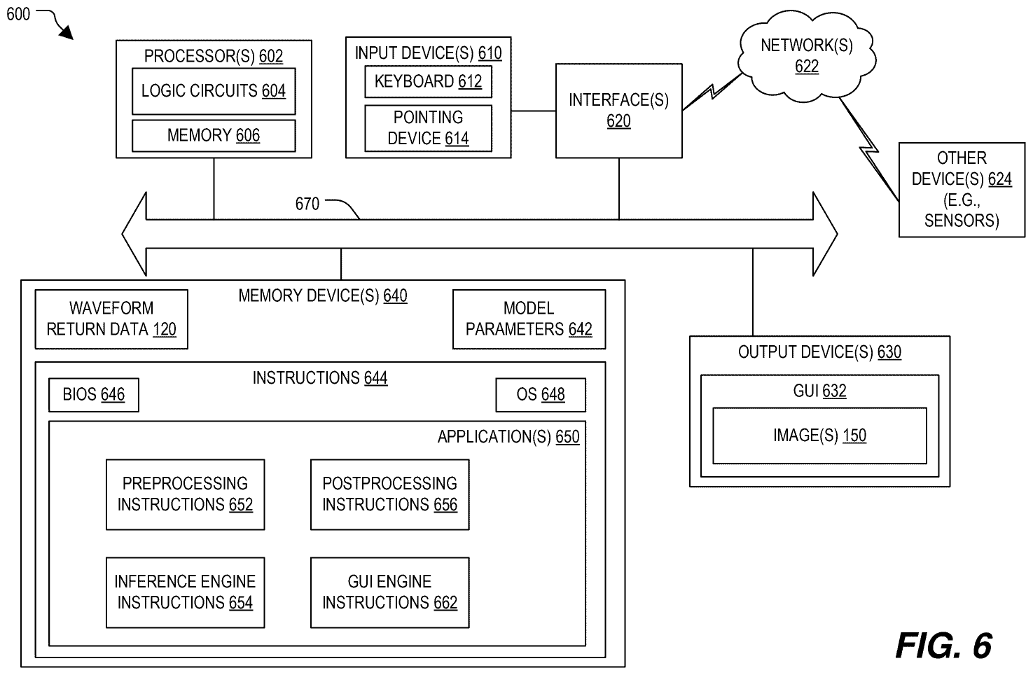

FIG. 4 illustrates a flow chart of an example of a method of generating one or more images based on waveform return data in accordance with some aspects of the present disclosure. One or more operations described with reference to FIG. 4 may be performed by the system 100, such as by one or more computing devices that include the processor(s) 130. To illustrate, one or more of the operations described with reference to FIG. 4 may be performed by the computer system 600 of FIG. 6, such as by processor(s) 602 executing instructions 644.

The method 400 includes, at block 402, obtaining, by one or more processors, first data representing waveform returns in terms of time, location, and ray parameter. For example, the processor(s) 130 (or a component thereof, such as the preprocessor 132) can receive the waveform return data 120 directly or indirectly from the sensing system 102 of FIG. 1. To illustrate, the preprocessor 132 can be configured to perform the domain transform operation(s) 302, which include transforming the waveform return data 120 from time-domain data in terms of time, location, and amplitude to tau-p-domain data 304.

The method 400 includes, at block 404, providing, by the one or more processors, input data frames as input to one or more machine-learning models to generate output data in terms of time, location, and velocity, where each input data frame includes a sampled portion of the first data, an interpolated portion of the first data, or both. For example, the processor(s) 130 (or a component thereof, such as the preprocessor 132) can provide the input data frames 134 as input to the machine-learning model(s) 136. In this example, the input data frames 134 can include samples and/or interpolated portions of the waveform return data 120 after a domain transform to generate data in terms of time, location, and ray parameter. In some implementations the one or more machine-learning models include a multi-channel neural network (such as the multi-channel convolutional neural network 310 of FIG. 3), in which case each of the input data frames may be provided as input to a corresponding input channel of the multi-channel neural network. For example, in some such implementations, each input channel of the multi-channel neural network is associated with a corresponding ray parameter value. As an example, the machine-learning model(s) can include a multilayer contracting path and an expanding path. In the multilayer contracting path, each contracting path layer includes one or more residual blocks including multiple convolution layers with one or more skip connections. The expanding path includes at least one multipath refinement block including one or more residual blocks, one or more multi-resolution fusion blocks, and one or more chained residual pooling blocks.

The method 400 includes, at block 406, generating, by the one or more processors, one or more images based on the output data, where the one or more images represent structures of an observed area associated with the waveform returns. For example, the processor(s) 130 (or a component thereof, such as the postprocessor 140) can receive the output data 138 and generate the depth-domain image(s) 320. To illustrate, the postprocessor 140 can generate image(s) by performing the integration operations 316.

Using waveform return data represented in terms of tau, location, and ray parameter enables the method 400 to generate image efficiently and flexibly. For example, the use of input data frames in the tau-p domain to generate output data in the time-domain (e.g., as time-domain velocity model(s)) means the machine-learning model(s) do not need to learn complex domain transformations, which allows the machine-learning model(s) to generate more accurate output data. Further, the waveform return data represented in the tau-p domain can be readily framed or interpolated to the particular p values used for the input data frames, which enable use of a variety of sensing system configurations.

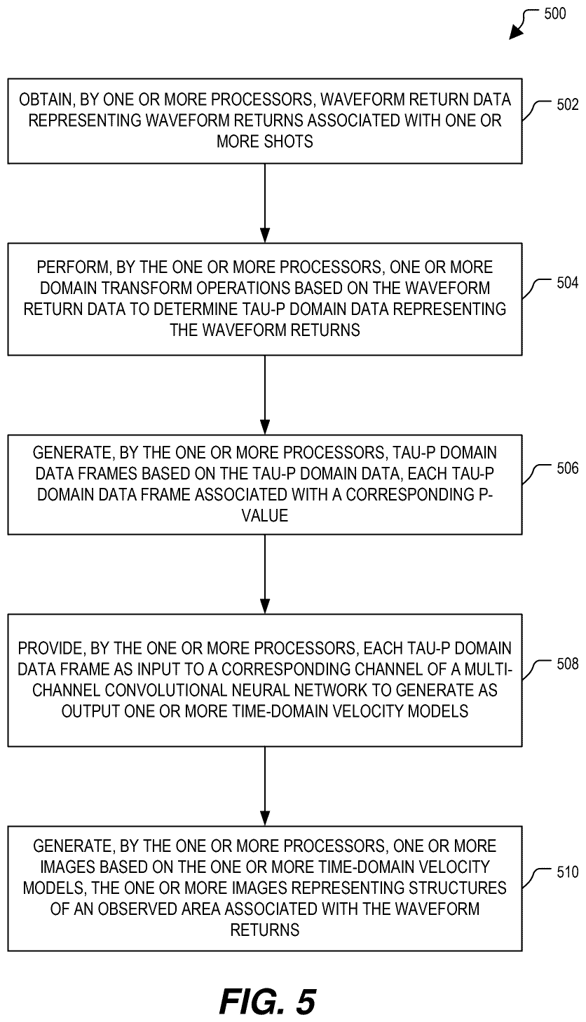

FIG. 5 illustrates a flow chart of an example of a method of generating one or more images based on waveform return data in accordance with some aspects of the present disclosure. One or more operations described with reference to FIG. 5 may be performed by the system 100, such as by one or more computing devices that include the processor(s) 130. To illustrate, one or more of the operations described with reference to FIG. 5 may be performed by the computer system 600 of FIG. 6, such as by processor(s) 602 executing instructions 644.

The method 500 includes, at block 502, obtaining, by one or more processors, waveform return data representing waveform returns associated with one or more shots. For example, the processor(s) 130 (or a component thereof, such as the preprocessor 132) can receive the waveform return data 120 directly or indirectly from the sensing system 102 of FIG. 1. In this example, the waveform return data 120 represents waveform returns associated with one or more shots.

The method 500 includes, at block 504, performing, by the one or more processors, one or more domain transform operations based on the waveform return data to determine tau-p domain data representing the waveform returns. For example, the preprocessor 132 can be configured to perform the domain transform operation(s) 302 to transform the waveform return data 120 from data in the time domain (e.g., time, location, and amplitude) to tau-p data in the tau-p-domain data 304 (e.g., in terms of location, tau, and ray parameter).

The method 500 includes, at block 506, generating, by the one or more processors, tau-p domain data frames based on the tau-p domain data, where each tau-p domain data frame is associated with a corresponding p value. For example, the preprocessor 132 can be configured to perform the framing and/or interpolation operations 306 to generate the p-value frame(s) 308 based on the tau-p-domain data 304.

The method 500 includes, at block 508, providing, by the one or more processors, each tau-p domain data frame as input to a corresponding channel of a multi-channel convolutional neural network to generate as output one or more time-domain velocity models. For example, the processor(s) 130 (or a component thereof, such as the preprocessor 132) can provide the input data frames 134 as input to the machine-learning model(s) 136. In this example, the input data frames 134 can include the p-value frame(s) 308. In some implementations the one or more machine-learning models 136 include a multi-channel neural network (such as the multi-channel convolutional neural network 310 of FIG. 3), in which case each of the input data frames may be provided as input to a corresponding input channel of the multi-channel neural network. For example, in some such implementations, each input channel of the multi-channel neural network is associated with a corresponding ray parameter value. As an example, the machine-learning model(s) can include a multilayer contracting path and an expanding path. In the multilayer contracting path, each contracting path layer includes one or more residual blocks including multiple convolution layers with one or more skip connections. The expanding path includes at least one multipath refinement block including one or more residual blocks, one or more multi-resolution fusion blocks, and one or more chained residual pooling blocks.

The method 500 includes, at block 510, generating, by the one or more processors, one or more images based on the one or more time-domain velocity models, the one or more images representing structures of an observed area associated with the waveform returns. For example, the processor(s) 130 (or a component thereof, such as the postprocessor 140) can receive the output data 138 (e.g., the time-domain velocity model(s) 312) and generate the depth-domain image(s) 320. To illustrate, the postprocessor 140 can generate image(s) 150 by performing the integration operations 316.

Providing tau-p domain data as input to the machine-learning model(s) to generate output data in the time-domain (e.g., as time-domain velocity model(s)) means the machine-learning model(s) do not need to learn complex domain transformations, which allows the machine-learning model(s) to generate more accurate output data. Further, representing the input data frames in the tau-p domain data enables a significant reduction in the size of the dataset, which reduces the computing resources (e.g., memory, processor time, power) used to generate the image(s) 150. Further, the waveform return data represented in the tau-p domain can be readily framed or interpolated to the particular p values used for the input data frames, which enables use of a variety of sensing system configurations.

FIG. 6 illustrates an example of a computer system 600 configured to generate image data based on waveform returns in accordance with some aspects of the present disclosure. For example, the computer system 600 is configured to initiate, perform, or control one or more of the operations described with reference to FIGS. 1-5. The computer system 600 can be implemented as or incorporated into one or more of various other devices, such as a personal computer (PC), a tablet PC, a server computer, a personal digital assistant (PDA), a laptop computer, a desktop computer, a communications device, a wireless telephone, or any other machine capable of executing a set of instructions (sequential or otherwise) that specify actions to be taken by that machine. Further, while a single computer system 600 is illustrated, the term “system” includes any collection of systems or sub-systems that individually or jointly execute a set, or multiple sets, of instructions to perform one or more computer functions. While FIG. 6 illustrates one example of the computer system 600, other computer systems or computing architectures and configurations may be used for carrying out the operations disclosed herein.

The computer system 600 includes one or more processors 602. In this context, the term “processor” refers to an integrated circuit consisting of logic circuits 604, interconnects, input/output blocks, clock management components, memory 606, and optionally other special purpose hardware components, designed to execute instructions and perform various computational tasks. Examples of processors include, without limitation, central processing units (CPUs), digital signal processors (DSPs), neural processing units (NPUs), graphics processing units (GPUs), field programmable gate arrays (FPGAs), microcontrollers, quantum processors, coprocessors, vector processors, other similar circuits, and variants and combinations thereof.

Taking CPUs as a starting point, a CPU typically includes one or more processor cores, each of which includes a complex, interconnected network of transistors and other circuit components defining logic gates (e.g., the logic circuits 604), memory elements, etc. A core is responsible for executing instructions to, for example, perform arithmetic and logic operations. Typically, a CPU includes an Arithmetic Logic Unit (ALU) that handles mathematical operations and a Control Unit that generates signals to coordinate the operation of other CPU components, such as to manage operations of a fetch-decode-execute cycle.

CPUs and/or individual processor cores generally include local memory circuits (e.g., the memory 606), such as registers and cache to temporarily store data during operations. Registers include high-speed, small-sized memory units intimately connected to the logic cells of a CPU. Often registers include transistors arranged as groups of flip-flops, which are configured to store binary data. Caches include fast, on-chip memory circuits used to store frequently accessed data. Caches can be implemented, for example, using Static Random-Access Memory (SRAM) circuits.

Operations of a CPU (e.g., arithmetic operations, logic operations, and flow control operations) are directed by software and firmware. At the lowest level, the CPU includes an instruction set architecture (ISA) that specifies how individual operations are performed using hardware resources (e.g., registers, arithmetic units, etc.). Higher level software and firmware is translated into various combinations of ISA operations to cause the CPU to perform specific higher-level operations. For example, an ISA typically specifies how the hardware components of the CPU move and modify data to perform operations such as addition, multiplication, and subtraction, and high-level software is translated into sets of such operations to accomplish larger tasks, such as adding two columns in a spreadsheet. Generally, a CPU operates on various levels of software, including a kernel, an operating system, applications, and so forth, with each higher level of software generally being more abstracted from the ISA and usually more readily understandable by human users.

GPUs, NPUs, DSPs, microcontrollers, coprocessors, FPGAs, ASICS, and vector processors include components similar to those described above for CPUs. The differences among these various types of processors are generally related to the use of specialized interconnection schemes and ISAs to improve a processor's ability to perform particular types of operations. For example, the logic gates, local memory circuits, and the interconnects therebetween of a GPU are specifically designed to improve parallel processing, sharing of data between processor cores, and vector operations, and the ISA of the GPU may define operations that take advantage of these structures. As another example, ASICs are highly specialized processors that include similar circuitry arranged and interconnected for a particular task, such as encryption or signal processing. As yet another example, FPGAs are programmable devices that include an array of configurable logic blocks (e.g., interconnected sets of transistors and memory elements) that can be configured (often on the fly) to perform customizable logic functions.

A processor can be configured to perform a specific task by including, within the processor, specialized hardware to perform the task. Additionally, or alternatively, the processor can be configured to perform a specific task by loading and/or executing instructions (e.g., computer code) that, when executed, cause the processor to perform the specific task. Loading executable instructions to perform the task causes an internal configuration change in the processor that transforms what may otherwise be a general-purpose processor into a special purpose processor for performing the task.

The processor(s) 602 are configured to interact with other components or subsystems of the computer system 600 via a bus 670. The bus 670 is illustrative of any interconnection scheme serving to link the subsystems of the computer system 600, external subsystems or devices, or any combination thereof. The bus 670 includes a plurality of conductors to facilitate communication of electrical and/or electromagnetic signals between the components or subsystems of the computer system 600. Additionally, the bus 670 includes one or more bus controllers or other circuits (e.g., transmitters and receivers) that manage signaling via the plurality of conductors and that cause signals sent via the plurality of conductors to conform to particular communication protocols.

In FIG. 6, the computer system 600 includes one or more output devices 630, one or more input devices 610, and one or more interface devices 620. Each of the output device(s) 630, the input device(s) 610, and the interface device(s) 620 can be coupled to the bus 670 via a port or connector, such as a Universal Serial Bus port, a digital visual interface (DVI) port, a serial ATA (SATA) port, a small computer system interface (SCSI) port, a high-definition media interface (HDMI) port, or another serial or parallel port. In some implementations, one or more of the output device(s) 630, the input device(s) 610, and/or the interface device(s) 620 is coupled to or integrated within a housing with the processor(s) 602 and the memory device(s) 640, in which case the connections to the bus 670 can be internal, such as via an expansion slot or other card-to-card connector. In other implementations, the processor(s) 602 and the memory device(s) 640 are integrated within a housing that includes one or more external ports, and one or more of the output device(s) 630, the input device(s) 610, and/or the interface device(s) 620 is coupled to the bus 670 via the external port(s).

Examples of the output device(s) 630 include display devices, speakers, printers, televisions, projectors, or other devices to provide output of data (e.g., the image(s) 150) in a manner that is perceptible by a user. Examples of the input device(s) 610 include buttons, switches, knobs, a keyboard 612, a pointing device 614, a biometric device, a microphone, a motion sensor, or another device to detect user input actions. The pointing device 614 includes, for example, one or more of a mouse, a stylus, a track ball, a pen, a touch pad, a touch screen, a tablet, another device that is useful for interacting with a graphical user interface, or any combination thereof. A particular device may be an input device 610 and an output device 630. For example, the particular device may be a touch screen.

The interface device(s) 620 are configured to enable the computer system 600 to communicate with one or more other devices 624 directly or via one or more networks 622. For example, the interface device(s) 620 may encode data in electrical and/or electromagnetic signals that are transmitted to the other device(s) 624 as control signals or packet-based communication using pre-defined communication protocols. As another example, the interface device(s) 620 may receive and decode electrical and/or electromagnetic signals that are transmitted by the other device(s) 624. To illustrate, the other device(s) 624 may include sensor(s) that generate the waveform return data 120. The electrical and/or electromagnetic signals can be transmitted wirelessly (e.g., via propagation through free space), via one or more wires, cables, optical fibers, or via a combination of wired and wireless transmission.

The computer system 600 also includes the one or more memory devices 640. The memory device(s) 640 include any suitable computer-readable storage device depending on, for example, whether data access needs to be bi-directional or unidirectional, speed of data access required, memory capacity required, other factors related to data access, or any combination thereof. Generally, the memory device(s) 640 includes some combination of volatile memory devices and non-volatile memory devices, though in some implementations, only one or the other may be present. Examples of volatile memory devices and circuits include registers, caches, latches, many types of random-access memory (RAM), such as dynamic random-access memory (DRAM), etc. Examples of non-volatile memory devices and circuits include hard disks, optical disks, flash memory, and certain types of RAM, such as resistive random-access memory (ReRAM). Other examples of both volatile and non-volatile memory devices can be used as well, or in the alternative, so long as such memory devices store information in a physical, tangible medium. Thus, the memory device(s) 640 include circuits and structures and are not merely signals or other transitory phenomena (e.g., are non-transitory media, such as non-transitory computer-readable storage device(s)).

In the example illustrated in FIG. 6, the memory device(s) 640 store instructions 644 that are executable by the processor(s) 602 to perform various operations and functions. The instructions 644 include instructions to enable the various components and subsystems of the computer system 600 to operate, interact with one another, and interact with a user, such as a basic input/output system (BIOS) 646 and an operating system (OS) 648. Additionally, the instructions 644 include one or more applications 650, scripts, or other program code to enable the processor(s) 602 to perform the operations described herein.

For example, in FIG. 6, the instructions 644 include preprocessing instructions 652, inference engine instructions 654, postprocessing instructions 656, and graphical user interface (GUI) engine instructions 662. The preprocessing instructions 652 are executable by the processor(s) 602 to initiate, perform, or control any of the operations of the preprocessor 132 described with reference to FIGS. 1-5. The interference engine instructions 654 (in conjunction with model parameters 642 stored in the memory) are executable by the processor(s) 602 to initiate, perform, or control any of the operations of the machine-learning model(s) 136 described with reference to FIGS. 1-5. The postprocessing instructions 656 are executable by the processor(s) 602 to initiate, perform, or control any of the operations of the postprocessor 140 described with reference to FIGS. 1-5. The GUI engine instructions 662 are executable by the processor(s) 602 to generate a GUI 632 that includes (e.g., depicts) one or more of the image(s) 150 described with reference to FIGS. 1-5.

Particular aspects of the disclosure are highlighted in the following Examples:

According to Example 1, a device includes one or more processors configured to obtain first data representing waveform returns in terms of time, location, and ray parameter; provide, as input to one or more machine-learning models, input data frames to generate output data in terms of time, location, and velocity, wherein each input data frame includes a sampled portion of the first data, an interpolated portion of the first data, or both; and generate, based on the output data, one or more images representing structures of an observed area associated with the waveform returns.

Example 2 includes the device of Example 1, wherein to obtain the first data, the one or more processors are configured to obtain waveform return data representing the waveform returns in terms of time, location, and amplitude; and perform one or more domain transformation operations to generate the first data based on the waveform return data.

Example 3 includes the device of Example 1 or Example 2, wherein the one or more machine-learning models include a multi-channel neural network, and wherein each of the input data frames is provided as input to a corresponding input channel of the multi-channel neural network.

Example 4 includes the device of Example 3, wherein each input channel of the multi-channel neural network is associated with a corresponding ray parameter value.

Example 5 includes the device of any of Examples 1 to 4, wherein to generate the one or more images, the one or more processors are configured to perform integration operations.

Example 6 includes the device of any of Examples 1 to 5, wherein the one or more machine-learning models include a multilayer contracting path where each contracting path layer includes one or more residual blocks including multiple convolution layers with one or more skip connections; and an expanding path including at least one multipath refinement block including one or more residual blocks, one or more multi-resolution fusion blocks, and one or more chained residual pooling blocks.

According to Example 7, a method includes obtaining, by one or more processors, first data representing waveform returns in terms of time, location, and ray parameter; providing, by the one or more processors, input data frames as input to one or more machine-learning models to generate output data in terms of time, location, and velocity, wherein each input data frame includes a sampled portion of the first data, an interpolated portion of the first data, or both; and generating, by the one or more processors, one or more images based on the output data, wherein the one or more images represent structures of an observed area associated with the waveform returns.

Example 8 includes the method of Example 7, wherein obtaining the first data includes obtaining, by the one or more processors, waveform return data representing the waveform returns in terms of time, location, and amplitude; and performing, by the one or more processors, one or more domain transformation operations to generate the first data based on the waveform return data.

Example 9 includes the method of Example 7 or Example 8, wherein the one or more machine-learning models include a multi-channel neural network, and wherein each of the input data frames is provided as input to a corresponding input channel of the multi-channel neural network.

Example 10 includes the method of Example 9, wherein each input channel of the multi-channel neural network is associated with a corresponding ray parameter value.

Example 11 includes the method of any of Examples 7 to 10, wherein generating the one or more images includes performing, by the one or more processors, integration operations.

Example 12 includes the method of any of Examples 7 to 11, wherein the one or more machine-learning models include a multilayer contracting path where each contracting path layer includes one or more residual blocks including multiple convolution layers with one or more skip connections; and an expanding path including at least one multipath refinement block including one or more residual blocks, one or more multi-resolution fusion blocks, and one or more chained residual pooling blocks.

According to Example 13, a non-transitory computer-readable storage device stores instructions that are executable by one or more processors to cause the one or more processors to obtain first data representing waveform returns in terms of time, location, and ray parameter; provide, as input to one or more machine-learning models, input data frames to generate output data in terms of time, location, and velocity, wherein each input data frame includes a sampled portion of the first data, an interpolated portion of the first data, or both; and generate, based on the output data, one or more images representing structures of an observed area associated with the waveform returns.

Example 14 includes the non-transitory computer-readable storage device of Example 13, wherein to obtain the first data, the instructions cause the one or more processors to obtain waveform return data representing the waveform returns in terms of time, location, and amplitude; and perform one or more domain transformation operations to generate the first data based on the waveform return data.

Example 15 includes the non-transitory computer-readable storage device of Example 13 or Example 14, wherein the one or more machine-learning models include a multi-channel neural network, and wherein each of the input data frames is provided as input to a corresponding input channel of the multi-channel neural network.

Example 16 includes the non-transitory computer-readable storage device of Example 15, wherein each input channel of the multi-channel neural network is associated with a corresponding ray parameter value.

Example 17 includes the non-transitory computer-readable storage device of any of Examples 13 to 16, wherein to generate the one or more images, the instructions cause the one or more processors to perform integration operations.

Example 18 includes the non-transitory computer-readable storage device of any of Examples 13 to 17, wherein the one or more machine-learning models include a multilayer contracting path where each contracting path layer includes one or more residual blocks including multiple convolution layers with one or more skip connections; and an expanding path including at least one multipath refinement block including one or more residual blocks, one or more multi-resolution fusion blocks, and one or more chained residual pooling blocks.

According to Example 19, a device includes one or more processors configured to obtain waveform return data representing waveform returns associated with one or more shots; perform one or more domain transform operations based on the waveform return data to determine tau-p domain data representing the waveform returns; generate, based on the tau-p domain data, tau-p domain data frames, each tau-p domain data frame associated with a corresponding p value; provide each tau-p domain data frame as input to a corresponding channel of a multi-channel convolutional neural network to generate as output one or more time-domain velocity models; and generate, based on the one or more time-domain velocity models, one or more images representing structures of an observed area associated with the waveform returns.

According to Example 20, a method includes obtaining, by one or more processors, waveform return data representing waveform returns associated with one or more shots; performing, by the one or more processors, one or more domain transform operations based on the waveform return data to determine tau-p domain data representing the waveform returns; generating, by the one or more processors, tau-p domain data frames based on the tau-p domain data, each tau-p domain data frame associated with a corresponding p value; providing, by the one or more processors, each tau-p domain data frame as input to a corresponding channel of a multi-channel convolutional neural network to generate as output one or more time-domain velocity models; and generating, by the one or more processors, one or more images based on the one or more time-domain velocity models, the one or more images representing structures of an observed area associated with the waveform returns.

According to Example 21, a non-transitory computer-readable storage device storing instructions that are executable by one or more processors to cause the one or more processors to obtain waveform return data representing waveform returns associated with one or more shots; perform one or more domain transform operations based on the waveform return data to determine tau-p domain data representing the waveform returns; generate, based on the tau-p domain data, tau-p domain data frames, each tau-p domain data frame associated with a corresponding p value; provide each tau-p domain data frame as input to a corresponding channel of a multi-channel convolutional neural network to generate as output one or more time-domain velocity models; and generate, based on the one or more time-domain velocity models, one or more images representing structures of an observed area associated with the waveform returns.

The systems and methods illustrated herein may be described in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C #, Java, JavaScript, VBScript, Macromedia Cold Fusion, COBOL, Microsoft Active Server Pages, assembly, PERL, PHP, AWK, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of techniques for data transmission, signaling, data processing, network control, and the like.

The systems and methods of the present disclosure may be embodied as a customization of an existing system, an add-on product, a processing apparatus executing upgraded software, a standalone system, a distributed system, a method, a data processing system, a device for data processing, and/or a computer program product. Accordingly, any portion of the system or a module or a decision model may take the form of a processing apparatus executing code, an internet based (e.g., cloud computing) embodiment, an entirely hardware embodiment, or an embodiment combining aspects of the internet, software, and hardware. Furthermore, the system may take the form of a computer program product on a computer-readable storage medium or device having computer-readable program code (e.g., instructions) embodied or stored in the storage medium or device. Any suitable computer-readable storage medium or device may be utilized, including hard disks, CD-ROM, optical storage devices, magnetic storage devices, and/or other storage media. As used herein, a “computer-readable storage medium” or “computer-readable storage device” is not a signal.

Systems and methods may be described herein with reference to screen shots, block diagrams and flowchart illustrations of methods, apparatuses (e.g., systems), and computer media according to various aspects. It will be understood that each functional block of a block diagram and flowchart illustration, and combinations of functional blocks in block diagrams and flowchart illustrations, respectively, can be implemented by computer program instructions.

Computer program instructions may be loaded onto a computer or other programmable data processing apparatus to produce a machine, such that the instructions that execute on the computer or other programmable data processing apparatus create means for implementing the functions specified in the flowchart block or blocks. These computer program instructions may also be stored in a computer-readable memory or device that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

Although the disclosure may include one or more methods, it is contemplated that it may be embodied as computer program instructions on a tangible computer-readable medium, such as a magnetic or optical memory or a magnetic or optical disk/disc. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Changes and modifications may be made to the disclosed embodiments without departing from the scope of the present disclosure. These and other changes or modifications are intended to be included within the scope of the present disclosure, as expressed in the following claims.

What is claimed is:

1. A device comprising:
one or more processors configured to:
obtain first data representing waveform returns in terms of time, location, and ray parameter;
provide, as input to one or more machine-learning models, input data frames to generate output data in terms of time, location, and velocity, wherein each input data frame includes a sampled portion of the first data, an interpolated portion of the first data, or both; and
generate, based on the output data, one or more images representing structures of an observed area associated with the waveform returns.

2. The device of claim 1, wherein to obtain the first data, the one or more processors are configured to:
obtain waveform return data representing the waveform returns in terms of time, location, and amplitude; and
perform one or more domain transformation operations to generate the first data based on the waveform return data.

3. The device of claim 1, wherein the one or more machine-learning models include a multi-channel neural network, and wherein each of the input data frames is provided as input to a corresponding input channel of the multi-channel neural network.

4. The device of claim 3, wherein each input channel of the multi-channel neural network is associated with a corresponding ray parameter value.

5. The device of claim 1, wherein to generate the one or more images, the one or more processors are configured to perform integration operations using the output of the one or more machine-learning models.

6. The device of claim 1, wherein the one or more machine-learning models include:
a multilayer contracting path where each contracting path layer includes one or more residual blocks including multiple convolution layers with one or more skip connections; and
an expanding path including at least one multipath refinement block including one or more residual blocks, one or more multi-resolution fusion blocks, and one or more chained residual pooling blocks.

7. A method comprising:
obtaining, by one or more processors, first data representing waveform returns in terms of time, location, and ray parameter;
providing, by the one or more processors, input data frames as input to one or more machine-learning models to generate output data in terms of time, location, and velocity, wherein each input data frame includes a sampled portion of the first data, an interpolated portion of the first data, or both; and
generating, by the one or more processors, one or more images based on the output data, wherein the one or more images represent structures of an observed area associated with the waveform returns.

8. The method of claim 7, wherein obtaining the first data includes:
obtaining, by the one or more processors, waveform return data representing the waveform returns in terms of time, location, and amplitude; and
performing, by the one or more processors, one or more domain transformation operations to generate the first data based on the waveform return data.

9. The method of claim 7, wherein the one or more machine-learning models include a multi-channel neural network, and wherein each of the input data frames is provided as input to a corresponding input channel of the multi-channel neural network.

10. The method of claim 9, wherein each input channel of the multi-channel neural network is associated with a corresponding ray parameter value.

11. The method of claim 7, wherein generating the one or more images includes performing, by the one or more processors, integration operations using the output of the one or more machine-learning models.

12. The method of claim 7, wherein the one or more machine-learning models include:
a multilayer contracting path where each contracting path layer includes one or more residual blocks including multiple convolution layers with one or more skip connections; and
an expanding path including at least one multipath refinement block including one or more residual blocks, one or more multi-resolution fusion blocks, and one or more chained residual pooling blocks.

13. A non-transitory computer-readable storage device storing instructions that are executable by one or more processors to cause the one or more processors to:
obtain first data representing waveform returns in terms of time, location, and ray parameter;
provide, as input to one or more machine-learning models, input data frames to generate output data in terms of time, location, and velocity, wherein each input data frame includes a sampled portion of the first data, an interpolated portion of the first data, or both; and
generate, based on the output data, one or more images representing structures of an observed area associated with the waveform returns.

14. The non-transitory computer-readable storage device of claim 13, wherein to obtain the first data, the instructions cause the one or more processors to:
obtain waveform return data representing the waveform returns in terms of time, location, and amplitude; and
perform one or more domain transformation operations to generate the first data based on the waveform return data.

15. The non-transitory computer-readable storage device of claim 13, wherein the one or more machine-learning models include a multi-channel neural network, and wherein each of the input data frames is provided as input to a corresponding input channel of the multi-channel neural network.

16. The non-transitory computer-readable storage device of claim 15, wherein each input channel of the multi-channel neural network is associated with a corresponding ray parameter value.

17. The non-transitory computer-readable storage device of claim 13, wherein to generate the one or more images, the instructions cause the one or more processors to perform integration operations using the output by the one or more machine-learning models.

18. The non-transitory computer-readable storage device of claim 13, wherein the one or more machine-learning models include:
a multilayer contracting path where each contracting path layer includes one or more residual blocks including multiple convolution layers with one or more skip connections; and
an expanding path including at least one multipath refinement block including one or more residual blocks, one or more multi-resolution fusion blocks, and one or more chained residual pooling blocks.

19. A device comprising:
one or more processors configured to:
obtain waveform return data representing waveform returns associated with one or more shots;
perform one or more domain transform operations based on the waveform return data to determine tau-p domain data representing the waveform returns;
generate, based on the tau-p domain data, tau-p domain data frames, each tau-p domain data frame associated with a corresponding p value;
provide each tau-p domain data frame as input to a corresponding channel of a multi-channel convolutional neural network to generate as output one or more time-domain velocity models; and
generate, based on the one or more time-domain velocity models, one or more images representing structures of an observed area associated with the waveform returns.

20. A method comprising:
obtaining, by one or more processors, waveform return data representing waveform returns associated with one or more shots;
performing, by the one or more processors, one or more domain transform operations based on the waveform return data to determine tau-p domain data representing the waveform returns;
generating, by the one or more processors, tau-p domain data frames based on the tau-p domain data, each tau-p domain data frame associated with a corresponding p value;
providing, by the one or more processors, each tau-p domain data frame as input to a corresponding channel of a multi-channel convolutional neural network to generate as output one or more time-domain velocity models; and
generating, by the one or more processors, one or more images based on the one or more time-domain velocity models, the one or more images representing structures of an observed area associated with the waveform returns.

21. A non-transitory computer-readable storage device storing instructions that are executable by one or more processors to cause the one or more processors to:
obtain waveform return data representing waveform returns associated with one or more shots;
perform one or more domain transform operations based on the waveform return data to determine tau-p domain data representing the waveform returns;
generate, based on the tau-p domain data, tau-p domain data frames, each tau-p domain data frame associated with a corresponding p value;
provide each tau-p domain data frame as input to a corresponding channel of a multi-channel convolutional neural network to generate as output one or more time-domain velocity models; and
generate, based on the one or more time-domain velocity models, one or more images representing structures of an observed area associated with the waveform returns.
